(19) United States
(12) Patent Application Publication
(10) Pub. No.: US 2023/0056145 A1
(43) Pub. Date: Feb. 23, 2023

(54) METHOD, DEVICE AND COMPUTER STORAGE MEDIUM FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 17/792,560

(22) PCT Filed: Jan. 15, 2020
(86) PCT No.: PCT/CN2020/072291

§ 371 Date: Jul. 13, 2022

(51) Int. Cl. H04L 5/00; H04W 76/28; H04W 72/04

(52) U.S. Cl. CPC H04L 5/0007; H04W 76/28; H04W 72/0453

(57) ABSTRACT

Embodiments of the present disclosure relate to methods, devices and computer storage media for communication. A method comprises allocating, at a network device, resources for communicating reference signal (RS) sequences between a terminal device and the network device, wherein the resources are discontinuous in frequency domain; transmitting, to the terminal device, configuration information about the resources; and communicating the RS sequences between the terminal device and the network device over the resources. Embodiments of the present disclosure can greatly enhance SRS capacity and/or coverage when applied to SRS communication.

### TECHNICAL FIELD

Embodiments of the present disclosure generally relate to the field of telecommunication, and in particular, to methods, devices and computer storage media for communication.

### BACKGROUND

In the 3GPP meeting RAN #86, enhancements on Sounding Reference Signal (SRS) have been discussed. For example, it has been proposed to identify and specify enhancements on aperiodic SRS triggering to facilitate more flexible triggering and/or Downlink Control Information (DCI) overhead/usage reduction. It has also been proposed to specify SRS switching for up to 8 antennas. Moreover, it has been proposed to evaluate and specify the following mechanism(s) to enhance SRS capacity and/or coverage: SRS time bundling, increased SRS repetition, partial sounding across frequency.

Traditionally, a Zad-off Chu (ZC) sequence may be used as a SRS sequence and mapped to continuous resource blocks (RBs) for transmission, such that the ZC property (such as, constant amplitude) of the SRS sequence can be maintained and orthogonality based on cyclic shifts for the SRS sequence can be achieved. Regarding partial sounding across frequency, a SRS sequence may be mapped to discontinuous RBs for transmission. As such, the ZC property (such as, constant amplitude) of the SRS sequence cannot be maintained and cyclic shifts for difference SRS sequences cannot be used.

### SUMMARY

In general, example embodiments of the present disclosure provide methods, devices and computer storage media for communication.

In a first aspect, there is provided a method of communication. The method comprises: allocating, at a network device, resources for communicating reference signal (RS) sequences between a terminal device and the network device, wherein the resources are discontinuous in frequency domain; transmitting, to the terminal device, configuration information about the resources; and communicating the RS sequences between the terminal device and the network device over the resources.

In a second aspect, there is provided a method of communication. The method comprises: receiving, at a terminal device and from a network device, configuration information about resources allocated for communicating reference signal (RS) sequences between the terminal device and the network device; determining the resources based on the configuration information, wherein the resources are discontinuous in frequency domain; and communicating the RS sequences between the terminal device and the network device over the resources.

In a third aspect, there is provided a method of communication. The method comprises: allocating, at a network device, resources for communicating reference signal (RS) sequences between a terminal device and the network device, wherein the resources comprise a number of symbols to which Time Division-Orthogonal Covering Code (TD-OCC) is applied; transmitting, to the terminal device, configuration information about the resources; and communicating the RS sequences between the terminal device and the network device over the resources.

In a fourth aspect, there is provided a method of communication. The method comprises: receiving, at a terminal device and from a network device, configuration information about resources allocated for communicating reference signal (RS) sequences between the terminal device and the network device; determining the resources based on the configuration information, wherein the resources comprise a number of symbols to which Time Division-Orthogonal Covering Code (TD-OCC) is applied; and communicating the RS sequences between the terminal device and the network device over the resources.

In a fifth aspect, there is provided a network device. The network device comprises a processor and a memory coupled to the processor. The memory stores instructions that when executed by the processor, cause the network device to perform actions. The actions comprise: allocating resources for communicating reference signal (RS) sequences between a terminal device and the network device, wherein the resources are discontinuous in frequency domain; transmitting, to the terminal device, configuration information about the resources; and communicating the RS sequences between the terminal device and the network device over the resources.

In a sixth aspect, there is provided a terminal device. The network device comprises a processor and a memory coupled to the processor. The memory stores instructions that when executed by the processor, cause the terminal device to perform actions. The actions comprise: receiving, from a network device, configuration information about resources allocated for communicating reference signal (RS) sequences between the terminal device and the network device; determining the resources based on the configuration information, wherein the resources are discontinuous in frequency domain; and communicating the RS sequences between the terminal device and the network device over the resources.

In a seventh aspect, there is provided a network device. The network device comprises a processor and a memory coupled to the processor. The memory stores instructions that when executed by the processor, cause the network device to perform actions. The actions comprise: allocating resources for communicating reference signal (RS) sequences between a terminal device and the network device, wherein the resources comprise a number of symbols to which Time Division-Orthogonal Covering Code (TD-OCC) is applied; transmitting, to the terminal device, configuration information about the resources; and communicating the RS sequences between the terminal device and the network device over the resources.

In an eighth aspect, there is provided a terminal device. The network device comprises a processor and a memory coupled to the processor. The memory stores instructions that when executed by the processor, cause the terminal device to perform actions. The actions comprise: receiving, from a network device, configuration information about resources allocated for communicating reference signal (RS) sequences between the terminal device and the network device; determining the resources based on the configuration information, wherein the resources comprise a number of symbols to which Time Division-Orthogonal Covering Code (TD-OCC) is applied; and communicating the RS sequences between the terminal device and the network device over the resources.

In a ninth aspect, there is provided a computer readable medium having instructions stored thereon. The instructions, when executed on at least one processor, cause the at least one processor to perform the method according to the first aspect of the present disclosure.

In a tenth aspect, there is provided a computer readable medium having instructions stored thereon. The instructions, when executed on at least one processor, cause the at least one processor to perform the method according to the second aspect of the present disclosure.

In a eleventh aspect, there is provided a computer readable medium having instructions stored thereon. The instructions, when executed on at least one processor, cause the at least one processor to perform the method according to the third aspect of the present disclosure.

In a twelfth aspect, there is provided a computer readable medium having instructions stored thereon. The instructions, when executed on at least one processor, cause the at least one processor to perform the method according to the fourth aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrate an example communication network in which embodiments of the present disclosure can be implemented;

FIG. 2 illustrates an example process for RS communication in accordance with some embodiments of the present disclosure;

FIG. 3 illustrates an example of resource allocation for SRS communication in accordance with some embodiments of the present disclosure;

FIG. 4 illustrates a flowchart of an example method in accordance with some embodiments of the present disclosure;

FIG. 5 illustrates a flowchart of an example method in accordance with some embodiments of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ second,′ and the like may refer to different or same objects. Other definitions, explicit and implicit, may be included below.

In some examples, values, procedures, or apparatus are referred to as ‘best,’ ‘lowest,’ ‘highest,’‘minimum,’‘maximum,’ or the like. It will be appreciated that such descriptions are intended to indicate that a selection among many used functional alternatives can be made, and such selections need not be better, smaller, higher, or otherwise preferable to other selections.

As described above, in the 3GPP meeting RAN #86, enhancements on SRS have been discussed. For example, it has been proposed to identify and specify enhancements on aperiodic SRS triggering to facilitate more flexible triggering and/or DCI overhead/usage reduction. It has also been proposed to specify SRS switching for up to 8 antennas. Moreover, it has been proposed to evaluate and specify the following mechanism(s) to enhance SRS capacity and/or coverage: SRS time bundling, increased SRS repetition, partial sounding across frequency.

Traditionally, a ZC sequence may be used as a SRS sequence and mapped to continuous RBs for transmission, such that the ZC property (such as, constant amplitude) of the SRS sequence can be maintained and orthogonality based on cyclic shifts for the SRS sequence can be achieved.

In the 3GPP specification TS 38.211, it is specified that the SRS sequence for an SRS resource shall be generated according to:

r^{(p}^{ᵢ}⁾(n,l′)=r_{u,v}^{(α}^{ᵢ}^{,δ)}(n)

0≤n≤M_{sc,b}^{RS}−1

l′∈{0,1, . . . N_{symb}^{SRS}−1} (1)

where M_{sc,b}^{RS} is given by clause 6.4.1.4.3 of the 3GPP specification TS 38.211, r_{u,v}^{(α,δ)}(n) is given by clause 5.2.2 of the 3GPP specification TS 38.211 with δ=log₂(K_{TC}) and the transmission comb number K_{TC} is contained in the higher-layer parameter transmissionComb. The cyclic shift αᵢ for antenna port Pᵢ is given as:

$$\begin{matrix}{α}_{i} = 2 π \frac{{n}_{SRS}^{cs , i}}{{n}_{SRS}^{cs , max}} \\ {n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max}\end{matrix} , \qquad ( 2 )$$

where n_{SRS}^{cs}∈{0, 1, . . . , n_{SRS}^{cs,max}−1} is contained in the higher layer parameter transmissionComb. The maximum number of cyclic shifts is n_{SRS}^{cs,max}=12 if K_{TC}=4 and n_{SRS}^{cs,max}=8 if K^{TC}=2.

The sequence group u=(f_{gh}(n_{s,f}^{μ},l′)+n_{ID}^{SRS}) mod 30 and the sequence index v in clause 5.2.2 of the 3GPP specification TS 38.211 depends on the higher-layer parameter groupOrSequenceHopping in the SRS-Config IE. The SRS sequence identity n_{ID}^{SRS} is given by the higher layer parameter sequenceId in the SRS-Config IE and l′∈{0, 1, . . . , N_{symb}^{SRS}−1} is the OFDM symbol index within the SRS resource.
if groupOrSequenceHopping equals ‘neither’, neither group, nor sequence hopping shall be used and

$$\begin{matrix}{f}_{gh} ( {n}_{s , f}^{μ} , {l}^{′} ) = 0 \\ v = 0\end{matrix} \qquad ( 3 )$$

if groupOrSequenceHopping equals ‘groupHopping’, group hopping but not sequence hopping shall be used and

$$\begin{matrix}{f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30 \\ v = 0\end{matrix} \qquad ( 4 )$$

where the pseudo-random sequence c(i) is defined by clause 5.2.1 of the 3GPP specification TS 38.211 and shall be initialized with cᵢₙᵢₜ=n_{ID}^{SRS} at the beginning of each radio frame.
if groupOrSequenceHopping equals ‘sequenceHopping’, sequence hopping but not group hopping shall be used and

$$\begin{matrix}{f}_{gh} ( {n}_{s , f}^{μ} , {l}^{′} ) = 0 \\ v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}\end{matrix} \qquad ( 5 )$$

where the pseudo-random sequence c(i) is defined by clause 5.2.1 of the 3GPP specification TS 38.211 and shall be initialized with cᵢₙᵢₜ=n_{ID}^{SRS} at the beginning of each radio frame.

However, with respect to partial sounding across frequency, a SRS sequence may be mapped to discontinuous RBs for transmission. As such, the ZC property (such as, constant amplitude) of the SRS sequence cannot be maintained and cyclic shifts for the SRS sequence cannot be used.

Embodiments of the present disclosure provide a solution to solve the problems above and/or one or more of other potential problems. This solution provides a new solution of resource allocation for RS communication, which can greatly enhance SRS capacity and/or coverage when applied to SRS communication. Meanwhile, this solution can still use a ZC sequence as a SRS sequence while maintaining the ZC property of the SRS sequence and can achieve orthogonality based on cyclic shifts for the SRS sequence. Further, this solution allows TD-OCC to be applied to time resources used for SRS communication and ensures that no matter SRS sequences from different terminal devices are full overlapping or partial overlapping, orthogonality can be achieved.

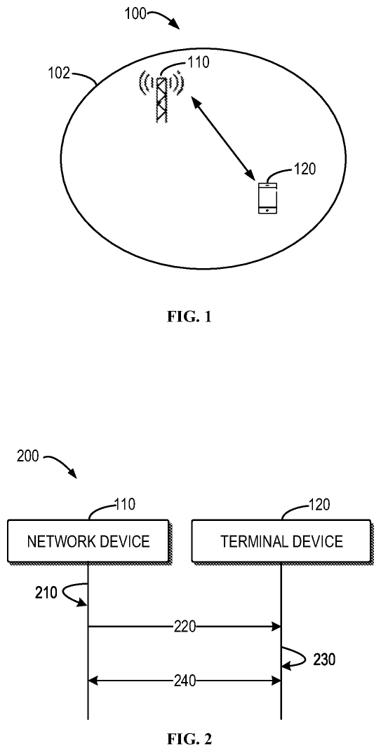

Principle and implementations of the present disclosure will be described in detail below with reference to FIGS. 1-6.

FIG. 1 shows an example communication network 100 in which implementations of the present disclosure can be implemented. The network 100 includes a network device 110 and a terminal device 120 served by the network device 110. The network 100 can provide at least one serving cell 102 to serve the terminal device 120. It is to be understood that the number of network devices, terminal devices and/or serving cells is only for the purpose of illustration without suggesting any limitations. The network 100 may include any suitable number of network devices, terminal devices and/or serving cells adapted for implementing implementations of the present disclosure.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 120.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device 120 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 120 from at least one of the first network device and the second network device. In one embodiment, first information may be transmitted to the terminal device 120 from the first network device and second information may be transmitted to the terminal device 120 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

In the communication network 100, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In addition to normal data communications, the network device 110 may send a RS to the terminal device 120 in a downlink. Similarly, the terminal device 120 may transmit a RS to the network device 110 in an uplink. Generally speaking, a RS is a signal sequence (also referred to as “RS sequence”) that is known by both the network device 110 and the terminal devices 120. For example, a RS sequence may be generated and transmitted by the network device 110 based on a certain rule and the terminal device 120 may deduce the RS sequence based on the same rule. Examples of the RS may include but are not limited to downlink or uplink Demodulation Reference Signal (DMRS), CSI-RS, Sounding Reference Signal (SRS), Phase Tracking Reference Signal (PTRS), Tracking Reference Signal (TRS), fine time-frequency Tracking Reference Signal (TRS), CSI-RS for tracking and so on. For the purpose of discussion without suggesting any limitations to the scope of the present disclosure, in the following description, some embodiments will be described with reference to SRS as an example of the RS. For example, SRS can be used by the network device 110 to perform uplink channel estimation, so as to perform resource allocation and configure transmission parameters for UL transmission from the terminal device 120 based on the result of the uplink channel estimation.

In transmission of downlink and uplink RSs, the network device 110 may assign corresponding resources for the transmission and/or specify which RS sequence is to be transmitted. In some scenarios, both the network device 110 and the terminal device 120 are equipped with multiple antenna ports (or antenna elements) and can transmit specified RS sequences with the antenna ports (antenna elements). A set of RS resources associated with a number of RS ports are also specified. A RS port may be referred to as a specific mapping of part or all of a RS sequence to one or more resource elements (REs) of a resource region allocated for RS communication in time, frequency, and/or code domains.

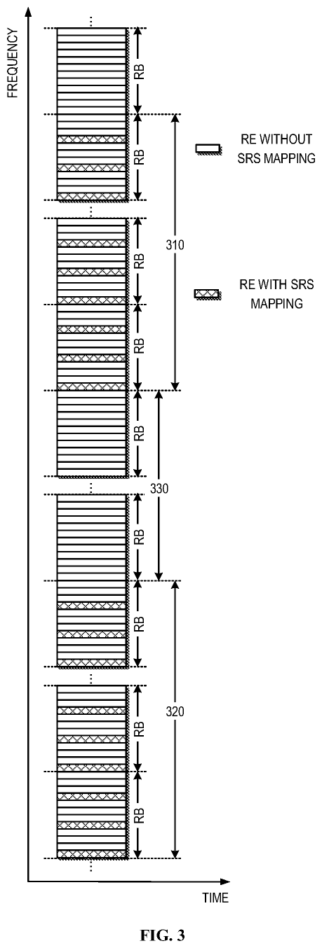

FIG. 2 shows a process 200 for RS communication according to some implementations of the present disclosure. For the purpose of discussion, the process 200 will be described with reference to FIG. 1. The process 200 may involve the network device 110 and the terminal device 120 as shown in FIG. 1. It is to be understood that the process 200 may include additional acts not shown and/or may omit some acts as shown, and the scope of the present disclosure is not limited in this regard.

As shown in FIG. 2, the network device 110 may allocate 210 resources for communicating RS sequences between the terminal device 120 and the network device 110. The network device 110 may then transmit 220, to the terminal device 120, configuration information about the resources. The terminal device 120 may receive 220 the configuration information from the network device 110 and determine 230 the resources based on the configuration information. Then, the network device 110 and the terminal device 120 may communicate 240 the RS sequences over the allocated resources. For example, the network device 110 may transmit DL RS sequences to the terminal device 120 over the allocated resources. Alternatively, the terminal device 120 may transmit UL RS sequences to the network device 110 over the allocated resource.

In some embodiments, the RS sequences may comprise sequences for any of the following: DMRS, CSI-RS, SRS, PTRS, TRS and so on. For the purpose of discussion without suggesting any limitations to the scope of the present disclosure, in the following description, embodiments of present disclosure will be described with reference to SRS as an example of the RS.

In some embodiments, the resources allocated for SRS communication may include RBs that are discontinuous in frequency domain. It is assumed that the bandwidth of the resources (also referred to as “SRS bandwidth”) is B RBs, where B is a positive integer. For example, 1≤B≤600. For another example, 1≤B≤276. In some embodiments, the B RBs may be divided into M groups, where M is a positive integer. For example, 1≤M≤32. For another example, 1≤M≤276. Each of the M groups may include N continuous RBs, where Nis a positive integer. For example, 1≤N≤32. For another example, N may be any of {1, 2, 3, 4, 6, 8, 12, 16, 32}. Two adjacent groups of the M groups may be separated by G RBs, where G is an integer and 0≤G≤32. For example, the G RBs may not be configured as the SRS resource. For another example, the G RBs may not be used for SRS communication. For example, a starting/first group of the M groups may include S continuous RBs, where S is an integer and 1≤S≤N. For another example, the starting/first group of the M groups may include N−(N_{BWP,i}^{start} mod N) continuous RBs, where N_{BWP,i}^{start} represents a starting position of a bandwidth part (BWP), and N_{BWP,i}^{start} is a non-negative integer. For example, 0≤N_{BWP,i}^{start}≤275. For another example, an ending/last group of the M groups may include L continuous RBs, where L is an integer and L≤N. For another example, the ending/last group of the M groups may include L continuous RBs, where L=(N_{BWP,i}^{start}+N_{BWP,i}^{size}) mod N if (N_{BWP,i}^{start}+N_{BWP,i}^{size}) mod N≠0 and L=(N_{BWP,i}^{start}+N_{BWP,i}^{size}) mod N if (N_{BWP,i}^{start}+N_{BWP,i}^{size}) mod N=0, where N_{BWP,i}^{start} is a starting position of a bandwidth part (BWP), and N_{BWP,i}^{start} is a non-negative integer. For example, 0≤N_{BWP,i}^{start}≤275. N_{BWP,i}^{size} represents the number of RBs in a BWP, and N_{BWP,i}^{size} is a positive integer. For example, 1≤N_{BWP,i}^{start}≤276. In some embodiments, the configuration information transmitted from the network device 110 to the terminal device 120 may indicate any of B, M, N and G. For example, the configuration information may be transmitted from the network device 110 to the terminal device 120 via any of the following: Radio Resource Control (RRC) signaling, Media Access Control (MAC) Control Element (CE) or DCI.

In some embodiments, a corresponding SRS sequence may be mapped to each of the M groups. It is assumed that a comb value (that is, the transmission comb number contained in the higher-layer parameter transmissionComb) applied to a given group of the M groups is represented as K_TC. In some embodiments, a length of the SRS sequence mapped to the given group may be determined as: M*RB_SC/K_TC, where RB_SC represents the number of subcarriers or REs included in one RB. For example, RB_SC may be 12 and K_TC may be any of 1, 2, 4, 8 or 12. In this event, for example, the length of the SRS sequence mapped to the given group may be any of 6, 12, 24, 36 or 48. For another example, the length of the SRS sequence mapped to the given group may be 12*P, where P is a positive integer. For example, 1≤P≤32.

In some embodiments, one single SRS sequence may be mapped to each of the M groups. In some embodiments, SRS sequences mapped to different groups of the M groups may be the same. Alternatively, in other embodiments, SRS sequences mapped to different groups of the M groups may be different. For example, the SRS sequences mapped to different groups of the M groups may be generated based on different root sequences.

FIG. 3 illustrates an example of such embodiments. As shown in FIG. 3, for example, the SRS bandwidth may be divided into two groups 310 and 320, each including N continuous RBs for mapping a corresponding SRS sequence. For example, a SRS sequence S₁ may be mapped to the group 310, while a SRS sequence S₂ may be mapped to the group 320. G continuous RBs 330 may separate the groups 310 and 320. In some embodiments, the SRS sequence S₁ may be the same as the SRS sequence S₂. Alternatively, in some embodiments, the SRS sequence S₁ may be different from the SRS sequence S₂.

In some embodiments, for different comb values, the number of RBs (that is, N) within one of the M groups may be different. For example, if the comb value is 2, the number of RBs (that is, N) within one of the M groups may be X (where X is an integer and 1≤X≤32), that is, N=X For another example, if the comb value is 4, the number of RBs (that is, N) within one of the M groups may be 2X, that is, N=2X For another example, if the comb value is 6, the number of RBs (that is, N) within one of the M groups may be 3X, that is, N=3X For another example, if the comb value is 8, the number of RBs (that is, N) within one of the M groups may be 4X, that is, N=4X For another example, if the comb value is 12, the number of RBs (that is, N) within one of the M groups may be 6X, that is, N=6X.

In some embodiments, for partial sounding across frequency, the available comb values may be limited. For example, in some embodiment, the only available comb value may be 1. In this case, a SRS sequence may be mapped to RB_SC REs within one RB, for example, RB_SC=12. Additionally, in some embodiments, if each of the M groups includes only one RB (that is, N=1), then a length-12 SRS sequence can be used for each of the M groups.

In some embodiments, in each of the M groups, a corresponding SRS sequence may be mapped to only one RB. For different comb values applied to a given group of the M groups, corresponding SRS sequence structures applied to the given group may be different. For example, if the comb value is 2 (that is, in each RB, SRS communication may occupy 6 REs), then a length-6 Quadrature Phase Shift Keying (QPSK)/8 Phase Shift Keying (8PSK) sequence can be used as a SRS sequence for each of the M groups. In some embodiments, cyclic shifts may be used for orthogonality. Alternatively or in addition, in some embodiments, in one RB, length-2/length-3/length-6 Frequency Division-Orthogonal Covering Code (FD-OCC) may be used for orthogonality. For another example, if the comb value is 4 (that is, in each RB, SRS communication may occupy 3 REs), then a Pseudo-noise (PN) sequence can be used as a SRS sequence for each of the M groups. In some embodiments, cyclic shifts may be used for orthogonality. Alternatively or in addition, in some embodiments, in one RB, length-3 FD-OCC may be used for orthogonality.

In some embodiments, for partial sounding across frequency, the available comb values may be limited. For example, in some embodiment, the only available comb value may be 2. In this case, a SRS sequence may be mapped to RB_SC REs within one RB, for example, RB_SC=12. Additionally, in some embodiments, if each of the M groups includes only one RB (that is, N=1), then a length-6 SRS sequence can be used for each of the M groups. For example, the length-6 SRS sequence may be modulated with QPSK or 8PSK.

In some embodiments, cyclic shifts may be used for orthogonality. In the following, it is assumed that the maximum number of cyclic shifts is represented as n_CS_max. In some embodiments, the maximum number of cyclic shifts may be dependent on the number of continuous RBs (that is, N) in one of the M groups and/or the comb value (that is, K_TC). In some embodiments, the maximum number of cyclic shifts n_CS_max may be determined as: RB_SC/K_TC or RB_SC/K_TC*m, where RB_SC represents the number of subcarriers or REs included in one RB (for example, RB_SC=12), m is an integer and 1≤m≤M. For example, if N=1 and K_TC=4, then n_CS_max may be 3. For antoher example, if N=1 and K_TC=2, then n_CS_max may be 6. For antoher example, if N=2 and K_TC=4, then n_CS_max may be 3 or 6. For another example, if N=2 and K_TC=2, then n_CS_max may be 6 or 12.

In some embodiments, if N=1 and K_TC=4, then n_CS_max may be 12, and the available cyclic shift values may be any group of the following: {2π*0/12, 2π*4/12, 2π*8/12}; {2π*1/12, 2π*5/12, 2π*9/12}; {2π*2/12, 2π*6/12, 2π*10/12}; or {2π*3/12, 2π*7/12, 2π*11/12}. In some embodiments, if N=1 and K_TC=2, then n_CS_max may be 8 or 12, and the available cyclic shift values may be any group of the following: {2π*0/8, 2π*2/8, 2π*4/8, 2π*6/8}; {2π*1/8, 2π*3/8, 2π*5/8, 2π*7/8}; {2π*0/12, 2π*2/12, 2π*4/12, 2π*6/12, 2π*8/12, 2π*10/12}; or {2π*1/12, 2π*3/12, 2π*5/12, 2π*7/12, 2π*9/12, 2π*11/12}. In some embodiments, if N=2 and K_TC=4, then n_CS_max may be 12, and the available cyclic shift values may be any group of the following: {2π*0/12, 2π*4/12, 2π*8/12}; {2π*1/12, 2π*5/12, 2π*9/12}; {2π*2/12, 2n 6/12, 2π*10/12}; or {2π*3/12, 2π*7/12, 2π*11/12}; {2π*0/12, 2π*2/12, 2π*4/12, 2π*6/12, 2π*8/12, 2π*10/12}; or {2π*1/12, 2π*3/12, 2π*5/12, 2π*7/12, 2π*9/12, 2π*11/12}. In some embodiments, if N=2 and K_TC=2, then n_CS_max may be 8 or 12, and the available cyclic shift values may be any group of the following: {2π*0/8, 2π*2/8, 2π*4/8, 2π*6/8}; {2π*1/8, 2n 3/8, 2π*5/8, 2π*7/8}; {2π*0/12, 2π*2/12, 2π*4/12, 2π*6/12, 2π*8/12, 2π*10/12}; or {2π*1/12, 2π*3/12, 2π*5/12, 2π*7/12, 2π*9/12, 2π*11/12}.

Alternatively, or in addition, in some embodiments, TD-OCC can be enabled for time resources allocated for SRS communication, to enhance SRS capacity and/or coverage. In some embodiments, as shown in FIG. 2, the resources allocated 210 for SRS communication may include a number of symbols to which TD-OCC is applied. In this event, the configuration information transmitted 220 from the network device 110 to the terminal device 120 may include at least one of the following: an indication that TD-OCC is enabled for the resources; and the number of symbols to which TD-OCC is applied (also referred to as “TD-OCC length”).

In some embodiments, in order to achieve orthogonality, if TD-OCC is enabled for time resources allocated for SRS communication and the TD-OCC length is P symbols, SRS sequences mapped to the P symbols (for example, the P symbols associated with the same frequency resources, the same physical RB indices or the same RE indices) should be the same. For example, the TD-OCC length may be any of {2, 4, 6, 8, 12}. For another example, P may be any of {2, 4, 6, 8, 12}. In some embodiments, if TD-OCC is enabled for time resources allocated for SRS communication and the TD-OCC length is P symbols, then group and sequence hopping may be disabled, such that SRS sequences mapped to the P symbols are the same. For example, the network device 110 may set the higher-layer parameter groupOrSequenceHopping as ‘neither’ and configure the higher-layer parameter groupOrSequenceHopping to the terminal device 120, so as to disable the group and sequence hopping. Alternatively, in some embodiments, if TD-OCC is enabled for time resources allocated for SRS communication, the TD-OCC length is P symbols and group or sequence hopping is enabled, then the symbol index 1′ as shown in the above equation (4) or (5) should be the same for the P symbols, such that SRS sequences mapped to the P symbols are the same. For example, l′ may be fixed to 0. For example, l′ may be fixed to any one of {1, 2, 3, 4, 5, 6, 7, 8, 9, 10, 11}. As such, no matter SRS sequences from different terminal devices are full overlapping or partial overlapping, orthogonality can be achieved.

In view of the above, it can be seen that embodiments of the present disclosure provide a new solution of resource allocation for RS communication, which can greatly enhance SRS capacity and/or coverage when applied to SRS communication. Meanwhile, this solution can still use a ZC sequence as a SRS sequence while maintaining the ZC property of the SRS sequence and can achieve orthogonality based on cyclic shifts for the SRS sequence. Further, this solution allows TD-OCC to be applied to time resources used for SRS communication and ensures that no matter SRS sequences from different terminal devices are full overlapping or partial overlapping, orthogonality can be achieved.

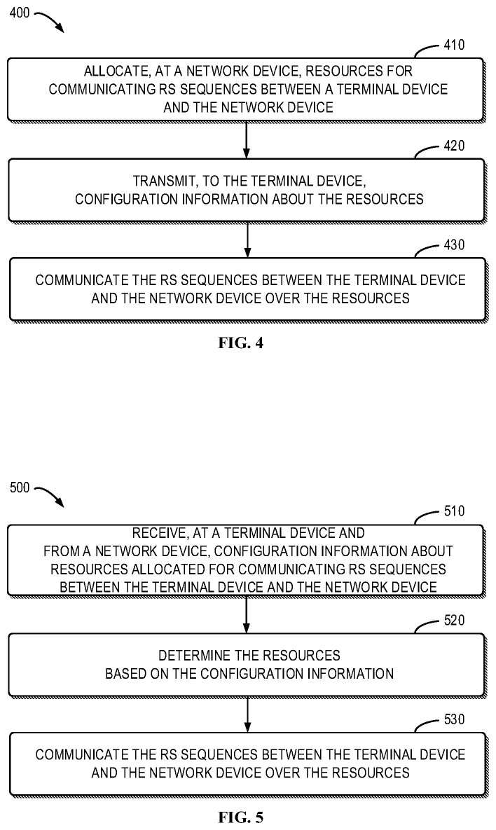

FIG. 4 illustrates a flowchart of an example method 400 in accordance with some embodiments of the present disclosure. The method 400 can be performed at the network device 110 as shown in FIG. 1. It is to be understood that the method 400 may include additional blocks not shown and/or may omit some blocks as shown, and the scope of the present disclosure is not limited in this regard.

At block 410, the network device 110 allocates resources for communicating RS sequences between the terminal device 120 and the network device 110.

At block 420, the network device 110 transmits, to the terminal device 120, configuration information about the resources.

At block 430, the network device 110 and the terminal device 120 communicates the RS sequences over the resources.

In some embodiments, the resources are discontinuous in frequency domain.

In some embodiments, the resources are divided into a first number of groups that are discontinuous in the frequency domain, two adjacent groups of the first number of groups are separated by a second number of frequency resources, and each of the first number of groups comprises a third number of continuous frequency resources for mapping a corresponding RS sequence.

In some embodiments, the configuration information comprises at least one of the following: a bandwidth of the resources; the first number; the second number; and the third number.

In some embodiments, the third number of continuous frequency resources comprised in a given group of the first number of groups is associated with a comb value applied to the given group.

In some embodiments, communicating the RS sequences comprises: determining, based on a comb value applied to a given group of the first number of groups, a RS sequence mapped to the given group; and communicating the RS sequence between the terminal device 120 and the network device 110 over the third number of continuous frequency resources comprised in the given group.

In some embodiments, the method 400 further comprises: determining, based on the third number and a comb value applied to a given group of the first number of groups, the maximum number of cyclic shifts supported in the given group.

In some embodiments, the resources comprise a number of symbols to which TD-OCC is applied.

In some embodiments, the configuration information comprises at least one of the following: an indication that TD-OCC is enabled for the resources; and the number of symbols to which TD-OCC is applied.

In some embodiments, communicating the RS sequences comprises: communicating a same RS sequence between the terminal device 120 and the network device 110 in each of the number of symbols.

In some embodiments, the RS sequences comprise sequences for any of the following: DMRS, CSI-RS, SRS, PTRS, and TRS.

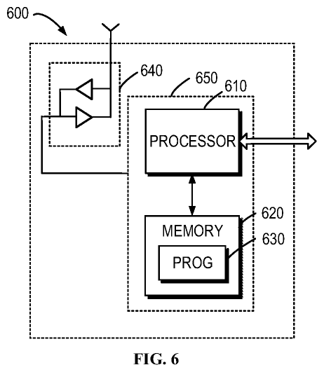

FIG. 5 illustrates a flowchart of an example method 500 in accordance with some embodiments of the present disclosure. The method 500 can be performed at the terminal device 120 as shown in FIG. 1. It is to be understood that the method 500 may include additional blocks not shown and/or may omit some blocks as shown, and the scope of the present disclosure is not limited in this regard.

At block 510, the terminal device 120 receives, from the network device 110, configuration information about resources allocated for communicating RS sequences between the terminal device 120 and the network device 110.

At block 520, the terminal device 120 determines the resources based on the configuration information.

At block 530, the terminal device 120 and the network device 110 communicate the RS sequences over the resources.

In some embodiments, the resources are discontinuous in frequency domain.

In some embodiments, the configuration information comprises at least one of the following: a bandwidth of the resources; a first number of groups into which the resources are divided; a second number of frequency resources that separate two adjacent groups of the first number of groups; and a third number of continuous frequency resources comprised in each of the first number of groups for mapping a corresponding RS sequence.

In some embodiments, the third number of continuous frequency resources comprised in a given group of the first number of groups is associated with a comb value applied to the given group.

In some embodiments, communicating the RS sequences comprises: determining, based on a comb value applied to a given group of the first number of groups, a RS sequence mapped to the given group; and communicating the RS sequence between the terminal device 120 and the network device 110 over the third number of continuous frequency resources comprised in the given group.

In some embodiments, the method 500 further comprises: determining, based on the third number and a comb value applied to a given group of the first number of groups, the maximum number of cyclic shifts supported in the given group.

In some embodiments, the resources comprise a number of symbols to which TD-OCC is applied.

In some embodiments, the configuration information comprises at least one of the following: an indication that TD-OCC is enabled for the resources; and the number of symbols to which TD-OCC is applied.

In some embodiments, communicating the RS sequences comprises: communicating a same RS sequence between the terminal device 120 and the network device 110 in each of the number of symbols.

In some embodiments, the RS sequences comprise sequences for any of the following: DMRS, CSI-RS, SRS, PTRS, and TRS.

FIG. 6 is a simplified block diagram of a device 600 that is suitable for implementing embodiments of the present disclosure. The device 600 can be considered as a further example implementation of the network device 110 or the terminal device 120 as shown in FIG. 1. Accordingly, the device 600 can be implemented at or as at least a part of the network device 110 or the terminal device 120.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 610 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 630 is assumed to include program instructions that, when executed by the associated processor 610, enable the device 600 to operate in accordance with the embodiments of the present disclosure, as discussed herein with reference to FIGS. 1 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 4 and/or FIG. 5. Generally, program modules include routines, programs, libraries, objects, classes, components, data structures, or the like that perform particular tasks or implement particular abstract data types. The functionality of the program modules may be combined or split between program modules as desired in various embodiments.

Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
allocating, at a network device, resources for communicating reference signal (RS) sequences between a terminal device and the network device, wherein the resources are discontinuous in frequency domain;
transmitting, to the terminal device, configuration information about the resources; and
communicating the RS sequences between the terminal device and the network device over the resources.

2. The method of claim 1, wherein:
the resources are divided into a first number of groups that are discontinuous in the frequency domain,
two adjacent groups of the first number of groups are separated by a second number of frequency resources, and
each of the first number of groups comprises a third number of continuous frequency resources for mapping a corresponding RS sequence.

3. The method of claim 2, wherein the configuration information comprises at least one of the following:
a bandwidth of the resources;
the first number;
the second number; and
the third number.

4. The method of claim 2, wherein the third number of continuous frequency resources comprised in a given group of the first number of groups is associated with a comb value applied to the given group.

5. The method of claim 2, wherein communicating the RS sequences comprises:
determining, based on a comb value applied to a given group of the first number of groups, a RS sequence mapped to the given group; and
communicating the RS sequence between the terminal device and the network device over the third number of continuous frequency resources comprised in the given group.

6. The method of claim 2, further comprising:
determining, based on the third number and a comb value applied to a given group of the first number of groups, the maximum number of cyclic shifts supported in the given group.

7. The method of claim 1, wherein the RS sequences comprise sequences for any of the following:
Demodulation Reference Signal (DMRS);
Channel State Information-Reference Signal (CSI-RS);
Sounding Reference Signal (SRS);
Phase Tracking Reference Signal (PTRS); and
Tracking Reference Signal (TRS).

8. A method of communication, comprising:
receiving, at a terminal device and from a network device, configuration information about resources allocated for communicating reference signal (RS) sequences between the terminal device and the network device;
determining the resources based on the configuration information, wherein the resources are discontinuous in frequency domain; and
communicating the RS sequences between the terminal device and the network device over the resources.

9. The method of claim 8, wherein the configuration information comprises at least one of the following:
a bandwidth of the resources;
a first number of groups into which the resources are divided;
a second number of frequency resources that separate two adjacent groups of the first number of groups; and
a third number of continuous frequency resources comprised in each of the first number of groups for mapping a corresponding RS sequence.

10. The method of claim 9, wherein the third number of continuous frequency resources comprised in a given group of the first number of groups is associated with a comb value applied to the given group.

11. The method of claim 9, wherein communicating the RS sequences comprises:
determining, based on a comb value applied to a given group of the first number of groups, a RS sequence mapped to the given group; and
communicating the RS sequence between the terminal device and the network device over the third number of continuous frequency resources comprised in the given group.

12. The method of claim 9, further comprising:
determining, based on the third number and a comb value applied to a given group of the first number of groups, the maximum number of cyclic shifts supported in the given group.

13. The method of claim 8, wherein the RS sequences comprise sequences for any of the following:
Demodulation Reference Signal (DMRS);
Channel State Information-Reference Signal (CSI-RS);
Sounding Reference Signal (SRS);
Phase Tracking Reference Signal (PTRS); and
Tracking Reference Signal (TRS).

14-17. (canceled)

18. A method of communication, comprising:
receiving, at a terminal device and from a network device, configuration information about resources allocated for communicating reference signal (RS) sequences between the terminal device and the network device;
determining the resources based on the configuration information, wherein the resources comprise a number of symbols to which Time Division-Orthogonal Covering Code (TD-OCC) is applied; and
communicating the RS sequences between the terminal device and the network device over the resources.

19. The method of claim 18, wherein the configuration information comprises at least one of the following:
an indication that TD-OCC is enabled for the resources; and
the number of symbols to which TD-OCC is applied.

20. The method of claim 18, wherein communicating the RS sequences comprises:
communicating a same RS sequence between the terminal device and the network device in each of the number of symbols.

21. The method of claim 18, wherein the RS sequences comprise sequences for any of the following:
Demodulation Reference Signal (DMRS);
Channel State Information-Reference Signal (CSI-RS);
Sounding Reference Signal (SRS);
Phase Tracking Reference Signal (PTRS); and
Tracking Reference Signal (TRS).

22-29. (canceled)
